(19) United States
(12) Patent Application Publication
(10) Pub. No.: US 2026/0139873 A1
(43) Pub. Date: May 21, 2026

(54) HIGH-TEMPERATURE HEATING APPARATUS

(71) Applicant: Hyperheat GmbH, Offenburg (DE)

(72) Inventors: Frederick LESSMANN, Köln (DE); Lars AMSBECK, Strasbourg (FR)

(73) Assignee: Hyperheat GmbH, Offenburg (DE)

(21) Appl. No.: 19/452,795

(22) Filed: Jan. 19, 2026

Related U.S. Application Data
(63) Continuation of application No. PCT/EP2024/071010, filed on Jul. 24, 2024.

(30) Foreign Application Priority Data
Jul. 25, 2023 (EP) 23 187 717.6

(51) Int. Cl. F24H 3/00; F24H 15/208; F24H 15/37; H05B 1/02; H05B 3/03; H05B 3/14

(52) U.S. Cl. CPC F24H 3/002; F24H 15/208; F24H 15/37; H05B 1/0244; H05B 3/03; H05B 3/141; F24H 2250/14; H05B 2203/016; H05B 2203/019

(57) ABSTRACT

A heating apparatus comprising a heating unit connected via connecting electrodes to an electrical unit, the heating unit being configured to heat fluid streams entering the heating apparatus along a longitudinal axis from an inlet temperature to an outlet temperature, wherein the heating unit comprises a first end that is connected via one of the connecting electrodes to a first electrode of the electrical unit, and a second opposite end that is connected via another one of the connecting electrodes to a second electrode of the electrical unit, the heating unit comprises a heating element, the heating element comprises an inlet end that is in electrical connection with the first and second ends of the heating unit, and is configured to receive the fluid streams having the inlet temperature, and the heating element comprises an outlet end that is configured to be heated above the outlet temperature.

### RELATED APPLICATION

This application is a continuation of international application No. PCT/EP2024/071010 filed on Jul. 24, 2024, and claims the benefit of European application No. EP 23 187 717.6 filed on Jul. 25, 2023, which are incorporated herein by reference in their entirety and for all purposes.

### FIELD OF DISCLOSURE

The present invention relates to generating heat for industrial processes from renewable energy. Specifically, the present invention relates to a heating apparatus and method for generating heat for industrial processes.

Industrial processes often necessitate high-temperature heating, which traditionally relies on non-renewable energy sources such as fossil fuels. In order to achieve the desired high temperatures industrial burners are widely used in various industries for combustion processes.

### BACKGROUND

However, one of the primary disadvantages of the known industrial burners resides in the emission of pollutants and greenhouse gases into the atmosphere. In particular, the combustion process produces byproducts such as carbon dioxide (CO₂), nitrogen oxides (NOₓ), sulfur dioxide (SO₂), and particulate matter, which contribute to air pollution and climate change. These emissions can have adverse effects on human health and the environment.

In other words, the conventional methods systems and methods for generating the desired high temperatures considerably contribute to carbon emissions and are not aligned with sustainable practices.

There is a need for a cost and energy-efficient solution that leverages renewable energy for generating heat in industrial processes while ensuring reliable performance and minimizing environmental harm.

### SUMMARY OF THE INVENTION

It is therefore an object of the present invention to address the drawbacks of the conventional approaches by providing for systems and methods that are configured to use renewable energy sources, such as electricity, to generate the high temperatures required in industrial processes.

In particular, this object is achieved by a heating apparatus for generating heat for industrial processes according to claim 1.

In particular, the heating apparatus comprises at least one heating unit that is connected via connecting electrodes to an electrical unit, wherein the at least one heating unit is configured to heat fluid streams entering the heating apparatus along a longitudinal axis from an inlet temperature to an outlet temperature, wherein the at least one heating unit comprises a first end that is connected via one of the connecting electrodes to a first electrode of the electrical unit, and a second opposite end that is connected via another one of the connecting electrodes to a second electrode of the electrical unit, wherein the at least one heating unit further comprises at least one heating element, wherein the at least one heating element comprises an inlet end that is in electrical connection with the first and second ends of the at least one heating unit, and is configured to receive the fluid streams having the inlet temperature, and wherein the at least one heating element further comprises an outlet end that is configured to be heated at least up to the outlet temperature.

Advantageously, the heating apparatus provides for a high-temperature heater which is based on the renewable energy sources, e.g. electricity. In particular, by way of the design feature and material used in the heating apparatus, it is possible to adjust the heating power of the heating apparatus depending on the industrial demand. In addition, the performance and longevity of the heating apparatus and its electrical connections have been improved.

In particular, the heating apparatus is configured to generate an outlet temperature at the outlet end that ranges between 600 and 2800° C., preferably between 1200 and 2800° C. Advantageously, by generating such high temperatures over a wide range of high temperatures it is possible to replace the industrial burners.

In particular, the at least one heating element comprises electrically conductive oxide materials with a negative temperature coefficient (NTC). One of the advantages of using the NTC material resides in a reduction of specific resistance by increasing the temperature. For example, the specific resistance can be reduced by more than 30% per 100° C. temperature rise.

For example, such conductive materials comprise oxide ceramics, oxide ceramics doped with metal oxides, stabilized oxide ceramics doped with metal oxides, or oxide ceramics fully stabilized with metal oxides.

In particular, the electrical unit and the heating unit are configured and designed such that uncontrolled temperature rises in the heating apparatus is prevented. This may occur due to a phenomenon such as thermal runaway. The potential for thermal runaway, for example, arises when the heating element comprising of an NTC material is subjected to a high-current condition or excessive power dissipation. As the current passing through the heating element, its temperature rises. As the temperature increases, the resistance decreases, which in turn leads to a higher current flow. This positive feedback loop can lead to significant increase of the temperature and current. The electrical unit is therefore configured to operate at a current-control mode or power-control mode, preventing undesired increase of the current passing through the heating elements of the heating unit.

On the other hand, the NTC allows for more homogeneous and with a given maximum element temperature therefore higher average outlet gas temperatures. In areas with colder gas temperatures due to mass flow inhomogeneities arising from higher gas densities at lower temperatures (“blow through effect”) the higher heating element resistance at lower temperatures and therefore higher heat generation at the same current limits the temperature differences in the outlet gas.

Utilizing heating elements with a negative temperature coefficient (NTC) offers significant advantages, including improved temperature homogeneity within the heating apparatus and increased average outlet gas temperatures. The higher resistance of NTC heating elements at lower temperatures aids in balancing heat distribution throughout the heating apparatus. In cooler regions, where the gas is denser, the elevated resistance of the heating elements generates more heat under same parameter (e.g. at the same current values). This, in turn, improves a more uniform heat distribution.

In particular, the at least one heating element comprises zirconia or conductive oxide ceramics such as yttria fully stabilized zirconia (e.g. 10 mol % Y₂O₃ fully stabilized ZrO₂), magnesia fully stabilized zirconia or calcium fully stabilized zirconia.

In particular, the connecting electrodes comprise a solid material. For example, the solid material includes metallic alloys, such as CrFe alloys (e.g. 95Cr5Fe), or conductive ceramics (e.g. tin oxide or Nb-doped titanium oxide or Mg-doped chromium oxide).

In particular, the connecting electrodes comprise conductive solid materials, e.g. in the form of wires or rods or tubes, that are configured to be electrically connected to the electrical unit and the heating unit.

In particular, the connecting electrodes are configured to be connected to the at least one heating element, e.g. using a press-connection, a pressure connection, sintering, soldering, blazing, conductive adhesive, thermal spraying, crimping or clamps.

In particular, the connecting electrodes comprise solid materials such as doped ceramics (e.g. Nb-doped TiO₂ or highly doped ZrO₂ or Mg-doped Cr₂O₃.), that are configured to connect the electrical unit to the heating unit (e.g. the first and second electrodes of the electrical unit to the first and second ends of the at least one heating unit.

In particular, the connecting electrodes (e.g. high-temperature connectors or intermediate connectors) are securely joined (or connected) to both ends of the heating unit (at inlet end of the at least one heating elements) through a pressure connection. This secure connection ensures reliable performance by maintaining consistent electrical contact, reducing the risk of connection failure due to thermal expansion or mechanical stress, and enhancing overall efficiency and durability.

In particular, ceramic insulation elements are provided to cover (or insulate), the connecting electrodes, e.g. high-temperature wires, to ensure electrical safety and prevent heat loss.

Advantageously the solid material provides for an easy assembly and connection of the electrodes while providing for a good electrical contact between the at least one heating unit (including the at least one heating element) and the first and second electrodes of the electronical unit.

Alternatively, the connecting electrodes comprise a liquid material, such as tin, tin alloys, CuZn alloys (brass), brazing alloys, silver, liquid salts or other materials which are liquid and electrically conductive in the temperature range of 1000-2200° C.

In particular, the heating apparatus comprises a container (e.g. comprising ceramic refractories) that is configured for containing the liquid electrode material.

In this example, the inlet end of the at least one heating element is configured to be immersed into (disposed within) the liquid material contained in the container.

In addition, the heating apparatus further comprises a cover lid that is configured to be disposed onto the container for protecting the liquid electrode material therein. For example, the cover lid is a liquid glass lid.

Alternatively, the liquid electrode material is configured to be encapsulated (or enclosed) in containers that are connected to the first end and the second end of the at least one heating unit.

For example, the containers are directly connected to (or are integral part of) the at least one heating element. Preferably, a container comprises sintered ceramics.

Advantageously by way of the liquid material, an efficient liquid electrode is provided that provides for low resistance but high-temperature electrical connections for the at least one heating element. This has one further advantage as no mechanical constraints is applied on the at least of heating element of the at least one heating unit.

In particular, the heating apparatus may comprise additional connecting electrodes functioning as interconnectors (resistive heaters) for pre-heating the heating unit.

In particular, the interconnectors (or the additional connecting electrodes) comprise liquid materials contained within a container (or a tube) made of a material similar to that of the at least one heating element. The container is configured to be securely connected to, or integrally formed with, the at least one heating element.

In particular, the interconnectors comprise two ends that are configured to be connected to an electrical source.

In particular, the connecting electrodes (interconnectors) are configured to be electrically connected to the heating unit (i.e. to the at least one heating element) for pre-heating to the heating unit (i.e. the at least one heating element of the heating unit).

The interconnectors are configured to be electrically connected to the at least one heating elements through pressure-assisted or compression elements, or mechanical clamps or soldering or crimping or sintering.

In particular, the compression elements comprise a compression fitting (e.g. a tube element) and at least one spring element connected to the tube. The compression elements are configured to generate an electrical connecting between the interconnectors and the heating elements through applied mechanical pressure.

By applying differential electrical potentials across the interconnectors, it is possible to accurately control current flow through the interconnectors, thereby generating heat to pre-heat the at least one heating element.

In particular, the heating apparatus further comprises a first shielding unit that is included (mounted) in the heating unit. For example, the shielding unit (or structure) is connected to or disposed to the at least one heating element, in particular at the proximity of the inlet end of the at least one heating unit.

In particular, the first shielding unit is configured to shield the connecting electrodes from the thermal radiation generated by the at least one heating element at the outlet end of the at least one heating unit. In this the performance and the lifetime of the connecting electrodes are improved.

Advantageously, the first shielding unit which receives the high-temperature radiations further enhances the heat transfer area to the fluid stream. In other words, more heat transfer area is provided through the shielding unit which is heated through thermal radiation from the at least one heating element.

For example, such a radiation shield and an improved heat transfer can be provided by the shielding unit comprising a permeable insulator material, such as a porous ceramic. One example of such material is a porous Al₂O₃.

Alternatively or additionally, the heating apparatus further comprises a second shielding unit to prevent the generation of electrical arc in the at least one heating unit between the electrical connections and the heating element. One example of such a material is dense Al₂O₃.

Advantageously, the second shielding unit gets radiated by the at least heating element and further enhances the heat transfer area to the fluid streams.

In particular, the at least one heating element further comprises a heating channel that is defined between the inlet end and outlet end of the at least one heating element. In other words, the at least one heating element provides for a heating channel that is configured to heat the fluid streams passing through the at least one heating unit, i.e. from the inlet end to the outlet end.

The heating channel has, for example, a curved shape (or geometry) with a constant or variable cross-section.

Advantageously, the at least one heating element has relatively small cross-section (i.e. the dimension of the heating channel along an axis perpendicular to the longitudinal axis) to thereby minimize (or reduce) the effects of electrical channeling due to the negative-temperature coefficient of resistance.

In this way advantageously localized heating, which may lead to temperature gradients and potential hotspots in the at least one heating element (e.g. ceramic materials) is prevented (or at least mitigated).

In particular, the heating channel is of a curved shape that includes at least two arms (e.g. at least two flange sections) extending, along the longitudinal axis, from the inlet end towards the outlet end, and at least one web-section that connects the at least two arms, wherein the web-section is disposed at the outlet end.

In particular, the at least one heating element is designed and adapted such that it provides for a heating channel that extends from an inlet end (i.e. the cold side) to an outlet end (hot side) and has a turning point at the outlet end, where it extends (back) towards the inlet end.

For example, the at least one heating element provides for a heating channel having a U-shape including two arms (e.g. of straight, curved or meander shape), wherein the free ends thereof define the inlet end.

In particular, the two arms can have a length (along the longitudinal axis) between 50 to 500 mm, and the web-section can have a width (the length along a transvers axis perpendicular to the longitudinal axis) between 10 to 300 mm.

In particular, the at least one heating element has a U-shape that includes two flange-sections (e.g. two arms) and a web-section (i.e. a common section connecting the two flange-sections).

For example, the flange-sections comprise two parallel and straight portions or two curved portions that extend along the longitudinal axis and are connected to the web-section (i.e. connected to the two ends of the web-section). Preferably, the web-section has a curved shape or a straight shape.

In particular, the heating channel is arranged in the heating unit such that the web-section is disposed at the outlet end of the at least one heating element (i.e. the hot side of the heating unit) and the two-flange sections are disposed at the inlet end of the at least one heating element (i.e. the cold side of the heating unit).

For example, the at least one heating element provides for a heating channel in an (inversed) U-form with the web-section forming the outlet end and the two flange-sections forming at the inlet end.

In particular, the web-section has a length between 50 to 500 mm, preferably 100 mm. More particularly, the flange-sections, each have a width between 10 to 50 mm, preferably 15 mm.

In particular, the second shielding unit is configured to be disposed between the two flange-sections (two arms) of the at least one heating element, to thereby prevent possible electric arcs.

Alternatively, the heating channel has a U-shape that includes two flange-sections extending along the longitudinal axis, and a web-section that is disposed at the outlet end, wherein each of the flange-sections are of a meander shape (a series of regular sinuous curves).

In this example, the web-section has a length between 80 to 500 mm, preferably 90 mm. Each of the flange-section have a width between 110 to 180 mm, preferably 140 mm. Preferably, the web-section has a curved or straight shape,

Alternativity, the at least one heating element provides for a heating channel that has a serpentine shape (e.g. a snake shape), wherein the free ends of the heating channel are disposed at the inlet end of the at least one heating and are, respectively, connected to the first and second ends of the at least one heating unit.

For example, the at least one heating element extends along the transvers axis between a first end and the second end of the at least heating element, wherein the free ends of the at least one heating element are configured to be connected to the connecting electrodes.

In particular, the connecting electrodes, each comprise a liquid electrode material that is encapsulated in a container, wherein the container is integral part of the at least one heating element or is configured to be attached to a free end of the at least on heating element.

For example, the heating apparatus comprises two containers including sintered ceramic materials that are formed at the free ends of the at least one heating element.

In particular, the heating apparatus further comprises a porous structure (or a porous element) that is disposed between two flange-sections along the longitudinal axis for facilitating radiative heat exchange therebetween.

In particular, the heating apparatus may comprise at least one heating unit that includes two or more heating elements, which heating elements are electrically connected in series. For example, an array of heating elements (1D or 2D array arrangements) are included in the heating unit.

In particular, the heating apparatus may comprise two or more heating units, each are connected to the electrical unit via the connecting electrodes.

In particular, it is further envisaged that the heating unit and/or the at least one heating element comprise materials, such as black zirconia to further enhance the radiative heat transfer.

In particular, the heating apparatus, for example, comprises a housing made of insulating materials for accommodating the at least one heating unit, wherein the housing comprises an outer casing that covers the outer periphery of the housing.

In addition, the present invention provides for a method of heating fluid streams for industrial processes, preferably the method is conducted using the heating apparatus of the present invention.

In particular, the method comprises:
optionally pre-heating at least one heating element (114) of the at least one heating unit (102) using an external metallic heater or a storage unit,
heating the at least one heating element (114) of the at least one heating unit (102) via an electronical unit, wherein the electronical unit is connected via connecting electrodes to an inlet end of the at least one heating element,
introducing fluid streams (108) through the inlet end (116) of the at least one heating element (114), and
controlling the temperature of the fluid streams (108), passing through the at least one heating element, at an outlet end (118) of the at least one heating element (114) using the electrical unit, wherein the electrical unit is configured to be operated in a current control mode.

Further preferred features and/or advantages of the present invention are the subject of the following description and the drawing of exemplary embodiments.

### BRIEF DESCRIPTION OF THE DRAWINGS

FIG. 1 a schematic front view of the heating apparatus for generating heat for industrial processes, inter alia comprising solid connecting electrodes;

FIG. 2 a schematic front view of the heating apparatus unit for generating heat for industrial processes, inter alia comprising a liquid electrode within a container;

FIG. 3 a schematic view of at least one heating element according to one example;

FIG. 4 a schematic view of at least one heating element according to another example;

FIG. 5 a schematic front view of the heating apparatus unit for generating heat for industrial processes, inter alia comprising a liquid electrode encapsulated in a container;

FIG. 6 a schematic top view of the heating unit for generating heat for industrial processes, indicating an example of the arrangement of the at least one heating unit;

FIG. 7 a schematic view of a heating apparatus including a second shielding unit;

FIG. 8 a schematic overview of the heating system and storage operation using a heating apparatus according to the present invention;

FIG. 9 a schematic top view of a heating apparatus indicating additional connecting electrodes for pre-heating a heating unit;

FIG. 10 a schematic top view of an apparatus indicating an example of a radiant heater;

FIG. 11 illustrates a schematic cross-sectional view of a heating apparatus, including connecting electrodes having a solid material; and

FIG. 12 a schematic partial view of a heating unit, indicating heating elements connected to solid connecting electrodes.

### DETAILED DESCRIPTION OF THE DRAWINGS

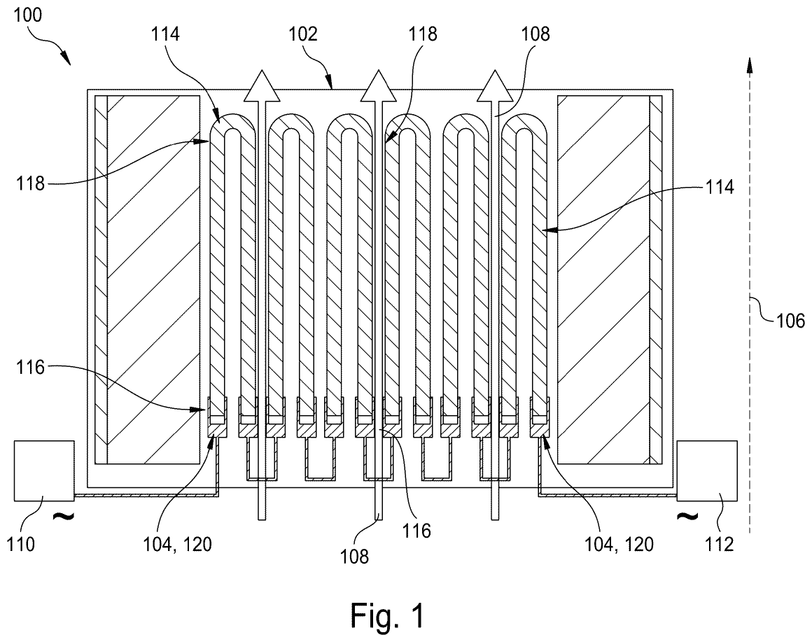

FIG. 1 illustrates a schematic front view of the heating apparatus 100 for generating heat for industrial processes.

The heating apparatus 100 comprises at least one heating unit 102 that is configured to be heated to high temperatures that are required for the industrial processes, for example the temperature as high as 2800° C.

The at least one heating unit is configured to be heated via renewable energy sources, such as electricity, to thereby eliminate (or at least reduce) the amount of carbon emission.

The heating apparatus is configured to generate an outlet temperature varies between 600 to 2800° C.

The heating apparatus 100 further comprises an electrical unit (not shown) that is connected via connecting electrodes 104 to the at least one electrical unit 102.

The heating apparatus comprises a housing 136 of insulating material for accommodating the at least one heating unit 102.

The housing 136, for example, comprises a casing 138 that is attached to the outer periphery of the housing. The housing and the casing are both configured to (e.g. comprise openings or slits) for electrically connecting the connecting electrodes 104 and the at least one electrical unit 102.

For example, the electrical unit is a power controller that is configured to be operates at a current control mode. In particular, the electronical unit is configured to measure resistance of the at least one heating element. The temperature of the at least one heating element can be estimated (derived) based on the measured resistance, which in turn allow to adjust or maintain the current applied to the heating element for obtaining the desired temperatures.

In this way, it is possible to accurately control the temperature of the heating elements within the heating units that are, for example, connected to different electrical units to thereby generate a uniform outlet temperature.

In operation, the heating system is configured to receive fluid streams 108 (e.g. a gas) via the at least one heating unit 102. The fluid streams 108 moves (or flows) along a longitudinal axis 106 thereby getting heated from an inlet temperature to an outlet temperature.

The at least one heating unit 102 comprises at least one heating element 114.

The at least one heating element 114 comprises an inlet end 116 which is configured to receive the fluid streams 108 entering the at least one heating unit 102.

The at least one heating element 114 further comprises an outlet end 118 at which the heated fluid stream is configured to exist the heating system.

For example, the outlet end is in fluid communication with an inlet or facilities of the industrial processes.

The heating system further comprises connecting electrodes 104 for electrically connecting the at least one heating unit 102 with the electrical unit.

In particular, the at least one heating unit 102 comprises a first end that is connected via one of the connecting electrodes 104 to a first electrode 110 of the electrical unit. Further, the at least one electrical unit 102 comprises a second (opposite) end that is connected via another one of the connecting electrodes 104 to a second electrode 112 of the electrical unit.

In this way reliable electrical connections are provided providing for flexible assembling of the at least one heating unit into the heating system.

For example, the connecting electrodes 104, 120 as shown in FIG. 1 comprises a solid material. The material for the connecting electrodes includes for example metallic alloys that represent good electrical properties at high temperatures.

In particular, the connecting electrodes are configured to reliably operate (when the at least one heating element has a temperature between 800 to 2800° C.) at voltages about 30 to 350 KV, e.g. 333 V, and a current between 0.1 to 50 A, e.g. 0.5 A.

One example of the material used for the connection electrode 95Cr5Fe.

In particular, the at least one heating element 114 comprises electrically conductive materials having a negative temperature coefficient.

For example, materials that are suitable to be used for the at least one heating element 114 comprise ceramics, oxide ceramics, oxide ceramics doped with metal oxides or stabilized oxide ceramics doped with metal oxides.

In one example the at least one heating material comprises ceramic materials including 8 mol % Y2O3 fully stabilized ZrO2.

This material has a negative temperature coefficient of resistance and shows following properties:
Specific resistance @1200K 0.25 Ωm
Specific resistance @1600K 0.03 Ωm
Specific resistance @2000K 0.009 Ωm

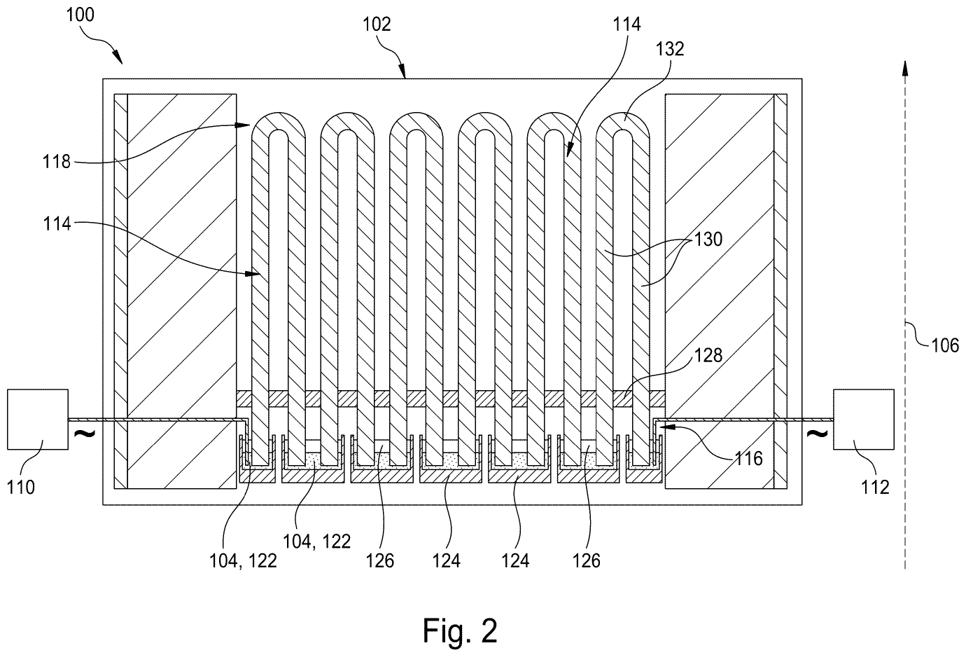

FIG. 2 illustrates another example of the heating apparatus 100 for generating heat for industrial processes heating.

The heating apparatus 100 comprises at least one heating unit 102 that is in electrical communication with the electrical unit similar to the example shown in FIG. 1.

The electrical connections between the at least one heating unit 102 (i.e. its heating elements 114) are provided via the connecting electrodes in the form of a liquid electrode.

The liquid electrode 122 is contained in a container 124, e.g. a refractory container. The container 124 comprises, for example, ceramic refractories like alumina or mullite. In the example, the at least one heating elements are disposed within the liquid electrode.

In particular, a cover lid 126 may be provided to cover the liquid electrode within the container 124, for example liquid glass or a liquid salt. In this way, the liquid electrode is further protected from undesired contamination like oxidation, which in turn provide for a better performance of the electrical connections.

The heating unit 102 as shown in FIGS. 1 and 2 may comprise a plurality of heating elements 114 that are connected in series.

The electrical connections between the heating elements 114 are provided by the connecting electrodes 104 (e.g. the solid connecting electrodes 120 in FIG. 1 and the liquid electrode 122 in FIG. 2).

The heating elements 114, i.e. one of the flange-section, are configured to electrically be connected to the first electrode and the second electrode of the electrical unit, respectively, at the first and second ends of the heating unit 102.

The heating system 100 may further comprise a unit or structure 128 for shielding the connecting electrodes 104 as shown in FIG. 2.

This first shielding unit 128 can be also included in the heating system 100 as indicated in FIG. 1

The first shielding unit 128 is configured to be disposed (arranged) in the heating unit 102. For example, the first shielding unit can be connected to the heating element 114, preferably close (or near) to the inlet end 116 of the heating element(s). In this way the high-temperature radiation from the outlet end towards the inlet end having lower temperatures (i.e. the so-called cold side of the heating unit) can be blocked by the shielding unit 128.

Advantageously, the first shielding structure 128 is configured to provide for dual functionality.

The primary function resides in protecting the electrical connections on the cold side of the heating system (that that provided by the connecting electrodes and the first and second electrodes of the electrical unit) from the thermal radiation of the so-called hot side of the heating system and the therewith associated damages.

According to a second function, the first shieling unit 128 which receives (collects) the thermal radiations is configured to heat the fluid streams. This in turn enhances the overall heat transfer area for heating the fluid streams 108.

In particular, the first shielding unit 128 comprises electrically insulating materials, such as ceramics. The shielding unit, for example, comprises voids or openings allowing the fluid streams to flow therethrough.

In particular, the first shielding unit 128 comprises gas permeable ceramic materials, such as porous Al₂O₃.

Other shielding structures that are configured to resist high temperatures are also suitable.

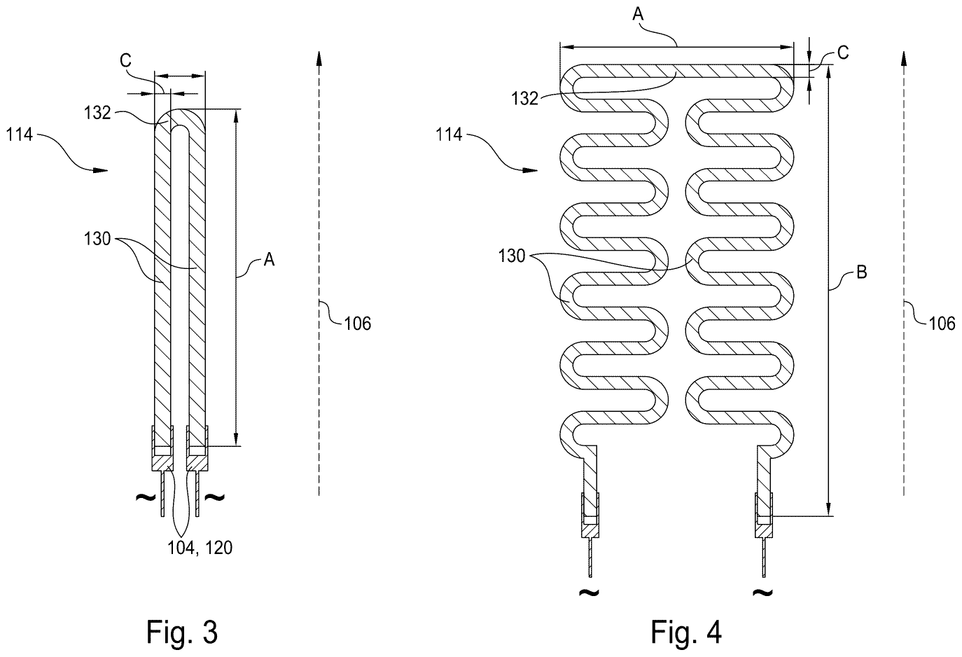

FIG. 3 illustrates an example of the heating element 114 used in the heating system 100 according to the present invention.

The heating element 114 or the heating rod has in this example a U shape including two parallel flange-sections 132 connected to the ends of a web-section 132.

In this example, the web-section is curved.

The dimensions of the heating element are adapted and designed such that the heating channel has cross-sections of different size or shape along the longitudinal axis.

For example, the shape of the cross-section of the heating element can be a circular, quadratics or oval, diamond or a combination thereof.

To reduce (or prevent) thermal channeling between the flanges, the shape of the heating element 114 are adapted to have relatively a small cross-section along a traversal axis (i.e. an axis perpendicular to the longitudinal axis 106).

The heating element are dimensioned such that a heating channel is formed extending between the inlet end and outlet end of the heating element.

The length of the heating element 114 along the longitudinal axis 106 may vary between 50 mm to 500 mm.

The connecting electrodes 104, 120 are connected to the free ends of the two flange-sections 130.

FIG. 4 illustrates another example of the heating element 114 that is used in the heating system 100 according to the present invention.

In this example, the heating element has specific U shape design. The web-section 132 is connected to the two-flange sections 130.

The web-section has a straight design and the flange sections includes a series of curved features forming a meander shape. In this way, the surface of the heating element is increased, thereby improving the heating of the fluid streams.

The heating element 114 is disposed in the heating unit such that the two-flanges extends along the longitudinal axis 106. In this way, the inlet end 116 of the heating element 114 is disposed at the cold side of the heating unit and the outlet end 118 is provided by the web-section 132.

In this example, the web-section 132 has a length between 80 to 120 mm (indicated with letter “A” in FIG. 4), preferably 90 mm. Each of the flange-sections 130 have a length between 110 to 180 mm, preferably 140 mm (indicated with letter “B” in FIG. 4).

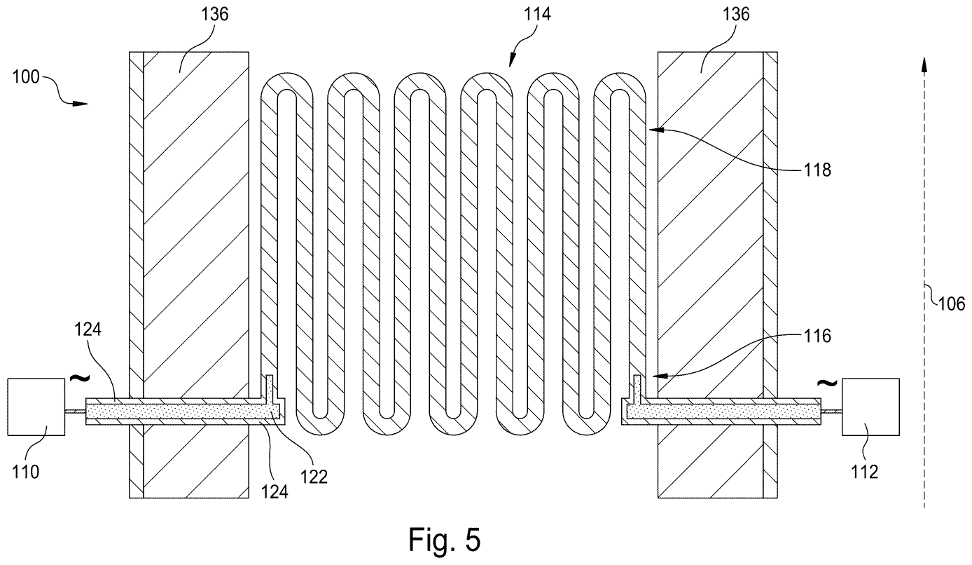

FIG. 5 illustrates another example of the heating apparatus 100 according to the present invention.

In this example, the heating apparatus 100 comprises at least one heating element 114 having a serpentine shape. The free ends of the at least one heating element 114 are connected via the connecting electrodes 104 to the electrical unit.

In particular, the connecting electrodes 104 are disposed at the first end and the second end of the at least heating unit 102. The connecting electrodes comprise a liquid electrode material 122 (e.g. tin) which is encapsulated in a container 124 (e.g. of sintered ceramic material).

For example, the connecting electrodes 104 are attached to the first and second ends of the at least one heating element 114. Alternatively, the connecting electrodes (e.g. the liquid encapsulated container) can be formed as an integral part of the at least one heating element 114.

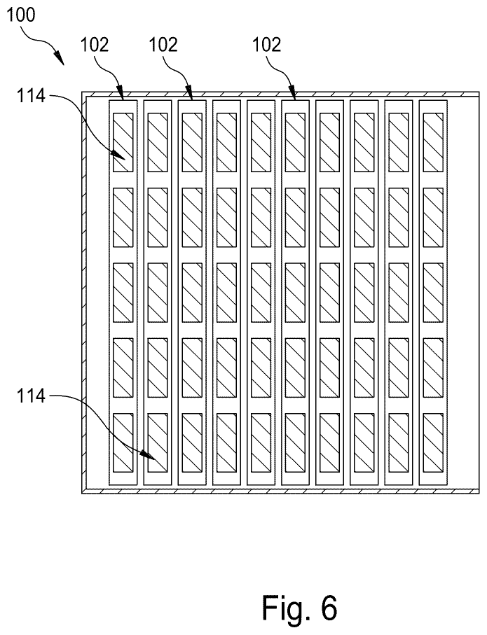

The heating element 114 as shown in FIG. 5 is also configured to be employed in an array arrangement for example as shown in FIG. 6.

FIG. 6 illustrates a schematic top view of the heating apparatus according to the present invention.

In this example, the heating apparatus comprises a plurality of heating units 102. The heating unit, each comprise an array of heating elements 114. The heating unit can be arranged either in 1D or 2D arrangements, i.e. including a row of the heating units or rows-columns of the heating units.

For example, an electronical unit is a current controlled electronical unit (e.g. a power supply in a current control mode).

For example, by a high-voltage power supply (e.g. 3 phases with 6 KV or higher) with a current of about 0.5 A and a voltage of 333 V per heating element, a power of about 10 kW can be generated by the heating apparatus comprising by 3 heating units (3 strings, one per phase), each including 20 heating elements that are connected in series.

In particular, the heating apparatus can be adapted to create a power of about 100 MW or higher using a plurality of strings and electronical units.

The heating elements 114 as shown in FIGS. 3 and 4 are both configured to be employed in the array arrangement as shown in FIG. 6.

In this way, it is possible to increase the capacity of the heating apparatus 100 and/or adjust the heating power depending on the industrial demand.

Advantageously, the arrangement and design of the heating apparatus 100 can easily be adapted to the corresponding industrial needs.

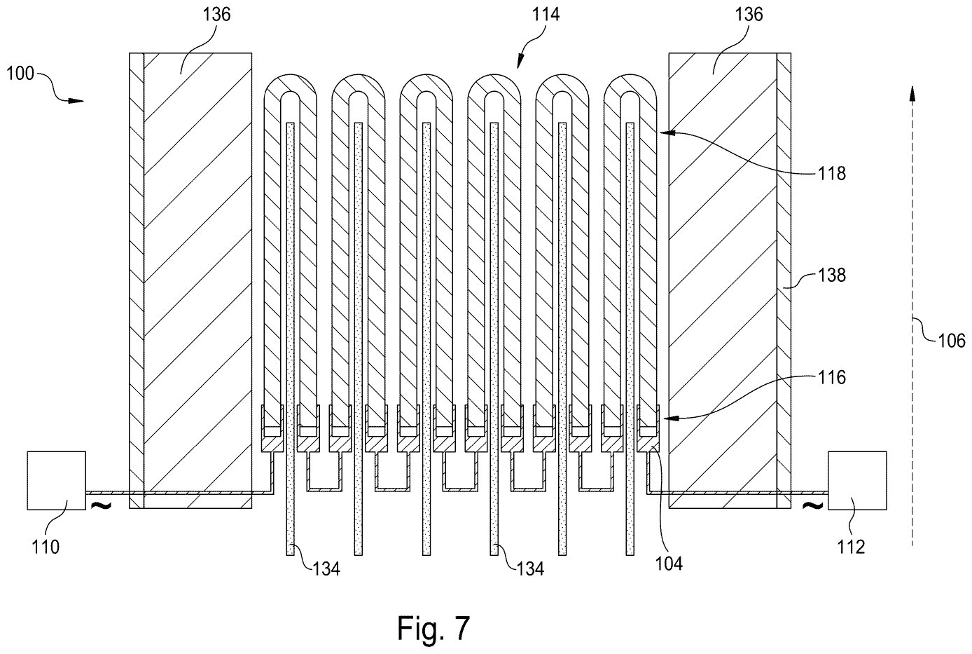

FIG. 7 illustrates a schematic view of a heating apparatus 100 including a second shielding unit 134.

In this example, the second shieling unit 134 is disposed in the at least one heating unit 102. For example, the second shielding unit 134 are configured to be disposed between the two arms (flange-sections) 130 of the at least one heating element 114.

The second shieling unit 134, for example, comprises dense refractory materials, such as alumina for preventing electrical arc when operating the heating apparatus 100.

In particular, the heating apparatus 100 can be used in a method for heating fluid streams and generating heat for industrial processes.

For example, the fluid streams can be pre-heated prior to be guided to the heating apparatus.

The heating elements of the heating unit are heated so that a heating channel is provided having an inlet temperature on the cold side and an outlet temperature on the hot side of the heating apparatus.

The fluid streams are entered into the heating unit and are get heated while flowing through the heating unit (or the heating elements).

The outlet temperature of the heating unit can be controlled by the electrical parameters applied to the heating elements via the electoral unit.

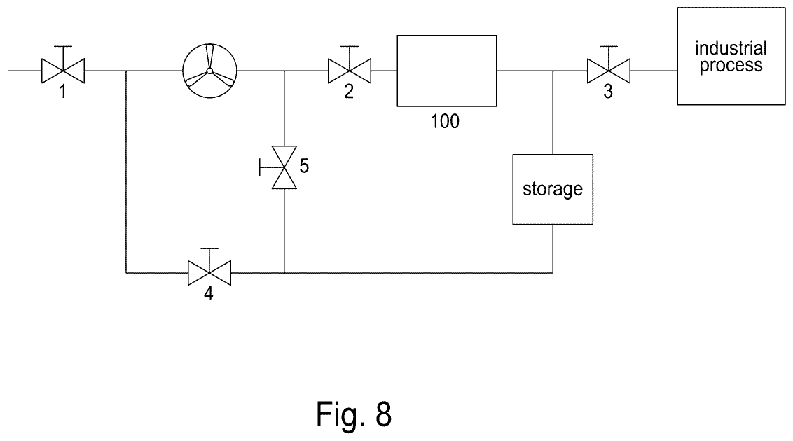

In FIG. 8 an overview of the heating system and storage operation using a heating apparatus according to the present invention is schematically illustrated. The system comprises a heating apparatus, a heat-storage unit and a plurality of valves 1, 2, 3, 4 and 5.

For example, the system can be configured to transfer heat from the heating apparatus into an industrial process. To this end, the valves 1, 2 and 3 are set to an open-state, while the valves 4 and 5 kept in a closed-state.

Alternatively, the system, for example, is configured to transfer heat from the heating apparatus and the storage unit into the industrial process. This may be the case when the power of the heating apparatus is less than the power demand in the industrial process. Accordingly, the valves 1 and 2 are brought into the open state, while valves 3 and 5 are set to a partial open-state. The valve 4 is kept in the closed state.

According to another example of the system operation, the system is configured to transfer heat from the heating apparatus into the storage unit and into the industrial process. This may be in particular the case when the power of the heating apparatus is higher (more) than the power demand in the industrial process.

To this end, the valves 1 and 2 are in the open-state, while the valves 3 and 4 are in the partially open state. The valve 5 is kept in the closed state.

According to yet another example, the system is configured to transfer heat from the storage unit into the industrial process, for example, when the demand of the industrial process is equal to the storage discharge.

Also, it is further possible that the system is configured to charge the storage unit, for example, when the demand for the industrial process is almost zero. In this case, the valves 2, 4 and 5 are in the open-state and the valves 1 and 3 are in the closed state.

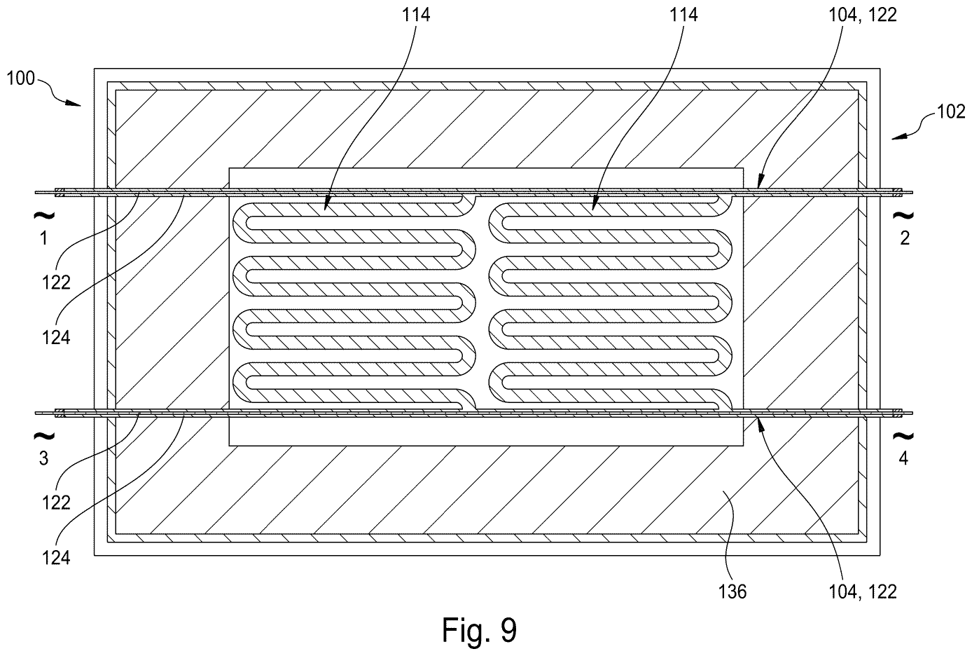

FIG. 9 illustrates a schematic top view of a heating apparatus, including additional connecting electrodes (or interconnectors) for pre-heating heating elements of a heating unit.

For example, the heating unit is similar to the heating unit 102 and comprises an array of heating elements 114 (in FIG. 9, only two heating elements 114 are shown as an example).

The additional connecting electrodes may be similar to the connecting electrodes 104 and are configured to be electrically connected to two or more of the heating elements 114.

In particular, each heating element 114 is configured to be electrically connected to two of the additional connecting electrodes 104.

For example, each free end of one heating element 114 is electrically connected to one of the connecting electrodes 104. The electrical connection can be provided by soldering, brazing, compression or sintering.

In this configuration, the two heating elements 114 are connected in parallel, with each end of the heating elements 114 being connected to the respective connecting electrodes 104. This parallel connection of the heating element with respect to the interconnectors (the additional connecting electrodes) 104 facilitates reliable and accurate heating of both the connecting electrodes 104 and the heating elements 114.

For example, the interconnectors 104 comprise a liquid electrode material 122, such as liquid metals (e.g., silver, tin, or platinum), encapsulated within a container 124 (e.g. made of sintered ceramics, doped ceramics, or refractory materials).

To pre-heat the connecting electrodes 104, the ends of the connecting electrodes 104 (such as connection ends 1 and 2, and connection ends 3 and 4) are initially set to different electrical potentials. This configuration allows electric current to flow through the connecting electrodes 104, thereby generating heat across the connecting electrodes 104. By establishing different potentials at the ends of the connecting electrodes 104, the electrical current is directed along an optimized path for heating the connecting electrodes 104.

Once the connecting electrodes 104 are heated to the desired temperature, the configuration can be adjusted to pre-heat the heating elements 114. Specifically, the connection ends 1 and 2 on one side of the heating unit 102 are set to the same potential, while the opposite connection ends 3 and 4 are set to an equal but different potential from the connection ends 1 and 2. This configuration directs the electrical current through the heating elements 114, thereby heating the heating elements 114.

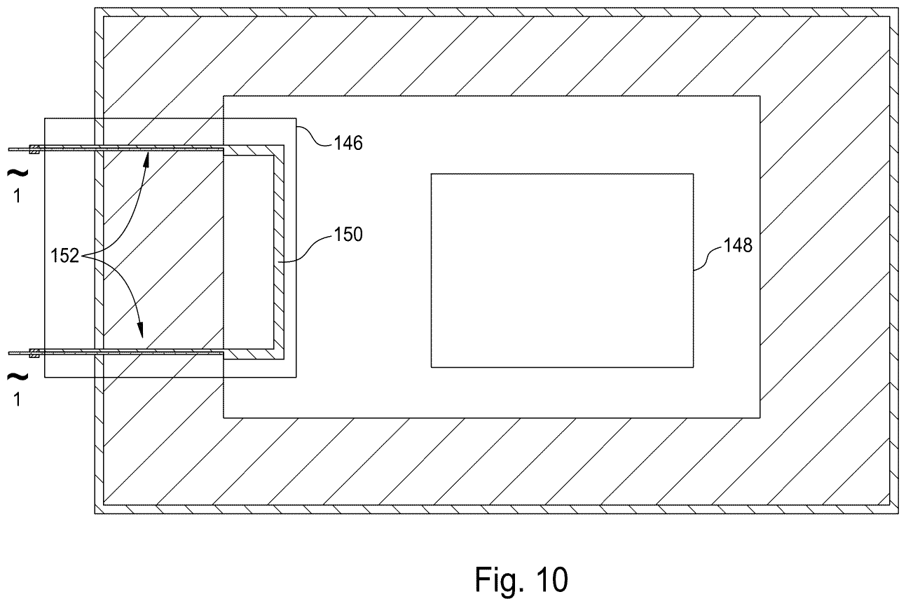

FIG. 10 illustrates a schematic top view of an apparatus.

The apparatus may comprise a thermal radiator (or a radiant heater) or a gas heater.

The apparatus further comprises a heater unit 146 that is configured to heat or pre-heat a target unit 148.

In this example, the apparatus comprises a thermal radiator. The target unit 148 is configured to be heated (warmed up) by the heat that is emitted from the heater unit 146 (a radiative heating process).

The radiated heat from the heater unit 146 is configured to transfer thermal energy to the target unit 148, raising its temperature to the desired temperatures as high 2600° C., e.g. 1000, 1200, 1400, 1600, 1800, 2000, 2200, 2200 or 2400° C.

The heater unit 146 comprises a heater element 150, wherein the heater element 150 that is electrically connected to an electrical unit via the heater connecting electrodes 152.

The heater elements 152 may be similar to the heating elements 114.

The heater unit 146 is further configured to be used as a pre-heating unit.

The heater element 150 comprises, for example, conductive oxide ceramics having a negative temperature coefficient such as doped-zirconia.

The at least one heating element of the heater element 150 may have a rectangular, curved or meander shape similar to the heating elements 114.

The heater connecting electrodes 152 comprises, for example, a liquid electrode material or a liquefiable material (e.g. Ag, Pt) contained in a conductive element or a tube or a container.

For example, the heater connecting electrodes comprise a liquid material, such as tin, tin alloys, CuZn alloys, brazing alloys, silver, liquid slats or other metals which are liquid in the temperature range of 1000 to 2200° C.

The conductive element comprises ceramic or doped ceramic materials, such as doped titania or highly doped zirconia or Mg-doped Cr₂O₃.

Alternatively, the heater connecting electrodes 152 may comprise a solid material (such as doped ceramics (e.g. Nb-doped TiO₂ or Mg-doped Cr₂O₃ or highly-doped ZrO₂).

For example, the target unit 148 comprises the heating unit 102 as described above. The heater connecting electrodes 152 are similar to the connecting electrodes 104 having liquid electrodes 122.

The heater connecting electrodes 152 are configured to be electrically connected to the heater element 150 (or the at least one heating element 114) via pressure assisted or compression bonding or soldering or sintering.

Alternatively, the target unit 148 comprises a heating device including at least one heating elements 114, wherein the at least one heating element is configured to be heated by radiant heat from the heater element 150.

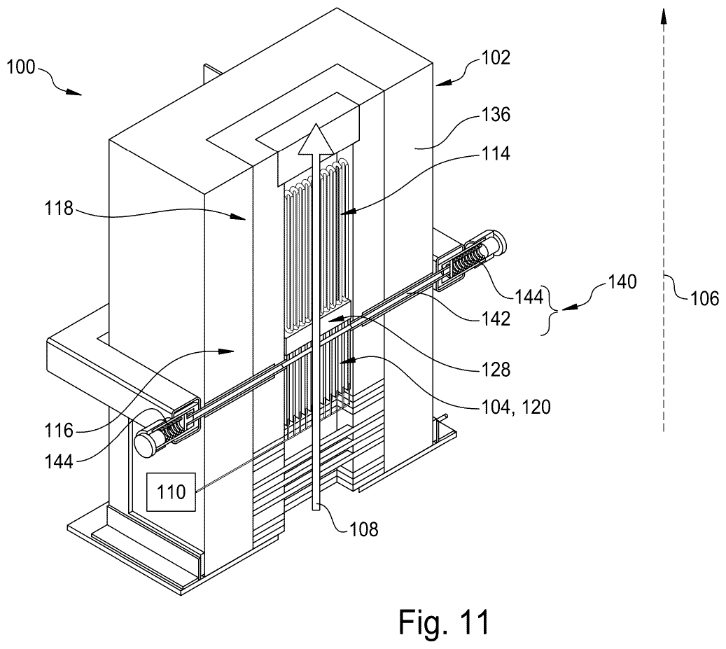

FIG. 11 illustrates a schematic cross-sectional view of a heating apparatus including connecting electrodes having a solid material.

The heating apparatus comprises a heating unit 102. The heating unit comprises at least one heating elements 114.

In this example, the heating apparatus comprises a plurality of heating elements that are connected in parallel.

In addition, in this example, the connecting electrodes 104 comprise solid materials, such as Nb-doped TiO₂.

The connecting electrodes 104 are disposed between the first electrode 110 and the second electrode (not visible in FIG. 10) of the electrical unit and the heating unit 102.

The first and second ends of the heating unit 102 are connected via the connecting electrode 104 to the electrical unit.

The solid connecting electrode 120 is configured to be electrically connected to the free ends of the at least one heating element 114.

For example, the solid connecting electrodes 104 are configured to connected to the free ends of the at least one heating element 114 through compression bonding applied by a compression element 140.

The compression element 140, for example, comprises a pressure fitting (e.g. a compression tube or connector) 142 and spring elements 144 that are arranged at one end or both ends of the compression tube 142.

The first shielding unit 128 is disposed at the proximity of the inlet end 116 of the at least one heating element 114 and upstream from the solid connecting electrodes 120 to protect the connecting electrodes 104 from thermal radiation.

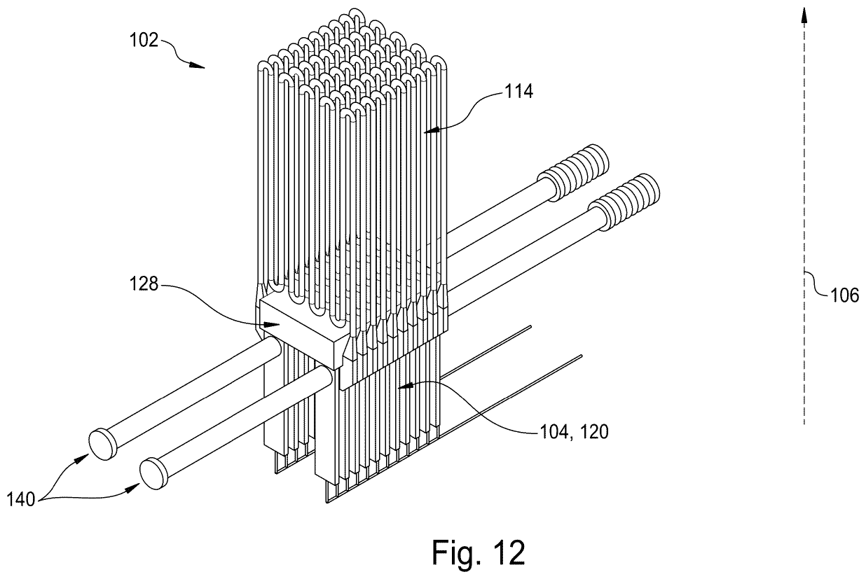

FIG. 12 illustrates a schematic partial view of the heating unit 102, indicating heating elements 114 connected to the solid connecting electrodes 104, 120.

The heating elements 114, for example, are of a U-shape, a meander shape or a serpentine shape as described above.

The first radiation shied 128 is configured to be disposed upstream from the solid connecting electrodes 120. For example, the first radiation shield 128 comprises ceramic foams, such as alumina foam, magnesia foam or zirconia foam.

In this example, the connecting electrodes 120 are configured to be electrically connected to the heating element 114 through the compression element 140. Any other suitable methods such as soldering, pressure-assisted conductive adhesive, brazing may be used as appropriate for creating electrical connections between the heating elements and connecting electrodes.

In particular, the present invention provides for a heating device comprising at least one heater element that is configured to be connected to heater connecting electrodes,

For example, the at least one heater element is similar to the at least one heating element 114 as described above. The heating device may comprise, for example, a heater unit 146 that comprises at least one heater element 114, 150.

The heater connecting electrodes 152 comprise a liquid material or a liquefiable material (e.g. a solid material that is configured to be molten at operation temperature).

For example, the heater connecting electrodes 152 (similar to the liquid connecting electrodes 122) comprises a conductive element (or a container 124) that is configured to contain (encapsulate) the liquid or liquefiable material.

The conductive element (or the container 124) comprises a conductive ceramic material.

The conductive element is configured to be connected to the at least one heating element through sintering.

The liquid material or the liquefiable material is configured to be contained in the conductive element. For example, the conductive element comprises tin, tin alloys, brass alloys, brazing alloys, silver, silver alloys, platinum, platinum alloys, liquid salts, or other metals which are liquid in the temperature range of 1000-2200° C.

For example, the at least one heater element 152 comprises two or more heater elements that are connected together in parallel (e.g. as shown in FIG. 9). The heater elements may be of a curved shape, meander shape, U-shape, rectangular shape.

In particular, the present invention further provides for a method for operating the heating device.

The method comprises the step of heating the connecting electrodes to a first operating temperature for heating the liquid material (contained in the conductive element) to a desired temperature or for heating the solid material in the form of the conductive element to a desired temperature.

Alternatively, the method comprises heating the connecting electrodes to a first operating temperature for melting the liquefiable material contained in the conductive element and for subsequently heating the molten material.

The method further comprises heating the heater element (or a heating unit comprising the heater elements) to a second operating temperature. The heating may be performed using an electrical unit that is configured to be connected to the heater connecting electrodes.

For example, the first operating temperature ranges from 900 to 2200° C., and the second operating temperature ranges from 1000 to 2600° C.

In particular, the present invention may further provide a method for manufacturing a heating device. The method comprises the steps of:
providing connecting electrodes, wherein the connecting electrodes comprise a conductive element (or a container) that is configured to contain (encapsulate) the liquid or liquefiable material;
providing a heating unit comprising at least one heating element;
connecting the connecting electrodes to the heating unit, preferably to the at least one heating element of the heating unit.

For example, the heating device comprises two or more heating elements 114 or heater elements 152 that are connected in series or in parallel.

For example, the conductive element comprises conductive ceramics, preferably similar to the material of the heating elements. The conductive element for example comprises doped ceramics such as Nb-doped TiO₂ or Mg-doped Cr₂O₃ or highly doped ZrO₂.

In particular, a method for operating a heating device is provided, the method comprising
heating the heater connecting electrodes 152 to a first operating temperature, wherein, when the heater connecting electrodes 152 comprise a liquefiable material, the liquefiable material is configured to be melted and subsequently heated to the operating temperature; and
heating the at least one heater element 150 to a second operating temperature, preferably using an electrical unit that is connected to the heater connecting electrodes 152, preferably the first operating temperature being smaller than the second operating temperature.

In particular, a method for manufacturing a heating device is provided, the method comprising
the heater connecting electrodes 152, wherein the heater connecting providing electrodes 152 comprise a solid material in the form of a conductive element, or wherein the heater connecting electrodes 152 comprise a liquid material or a liquefiable material that is configured to be contained in a conductive element;
providing at least one heater element 150, preferably the at least one heater element 150 comprising conductive ceramics or conductive oxide ceramics having a negative temperature coefficient;
connecting the heater connecting electrodes 152 to the at least one heater element 150, preferably through sintering or pressure assisted bonding;
optionally, providing a target unit 148, wherein the target unit is configured to be heated by the at least one heater element through radiant heat; and
optionally, assembling the heater connecting electrode and the heater connecting electrodes into a housing 136.

The heating apparatus according to the present invention provides for a renewable based heater capable of producing high-temperatures suitable for industrial processes. The capability and power of the heating apparatus can be easily adapted to the demand of the industrial processes. The heating apparatus according to the present inventions employs renewable electrical sources to thereby reduce carbon emission (the so-called zero carbon emission approach). The arrangement of the heating units and the number of the heating elements disposed therein can be reliably modified depending on the industrial demands. The connecting electrodes provides for a high-conductivity at high operation temperatures without adversely impacting the heating elements (no extra mechanical constraints). LIST OF REFERENCE SIGNS
100 heating apparatus
102 at least one heating unit
104 connecting electrodes,
106 longitudinal axis
108 fluid streams
110 first electrode
112 second electrode
114 at least one heating element
116 inlet end
118 outlet end
120 solid material
122 liquid material
124 refractory container
126 cover lid
128 first shielding unit
130 flange-section
132 web-section
134 second shielding unit
136 housing
138 casing
140 compression element
142 compression fitting
144 spring elements
146 heater unit
148 target unit
150 heater element
152 heater connecting electrodes

1. A heating apparatus for generating heat for industrial processes, the heating apparatus comprising:
at least one heating unit connected via connecting electrodes to an electrical unit, the at least one heating unit being configured to heat fluid streams entering the heating apparatus along a longitudinal axis from an inlet temperature to an outlet temperature, wherein the at least one heating unit comprises a first end that is connected via one of the connecting electrodes to a first electrode of the electrical unit, and a second opposite end that is connected via another one of the connecting electrodes to a second electrode of the electrical unit,
wherein the at least one heating unit further comprises at least one heating element, wherein the at least one heating element comprises an inlet end that is in electrical connection with the first and second ends of the at least one heating unit, and is configured to receive the fluid streams having the inlet temperature, and
wherein the at least one heating element further comprises an outlet end that is configured to be heated above the outlet temperature.

2. The heating apparatus according to claim 1,
wherein the outlet end is configured to be heated up to an outlet temperature of 600 to 2800 °C. or 1200 to 2800°C.

3. The heating apparatus according to claim 1,
wherein the at least one heating element comprises electrically conductive oxide ceramic materials having a negative temperature coefficient.

4. The heating apparatus according to claim 1,
wherein the electrical unit is configured to be operated at a current control mode to control the current applied to the at least one heating unit, including the at least one heating element, to thereby avoid thermal runaway in the heating apparatus.

5. The heating apparatus according to claim 1,
wherein the connecting electrodes comprise a solid material or a liquid material, and wherein the liquid electrode is either contained within a container or encapsulated within a container.

6. The heating apparatus according to claim 5,
wherein the liquid electrode is contained in the container and the inlet end of the at least one heating element is configured to be immersed into the liquid electrode, or
wherein the liquid electrode is encapsulated in the container and the container is attached to the at least one heating element.

7. The heating apparatus according to claim 1,
further comprising a cover lid configured to be disposed onto the container for protecting the liquid material contained in the container.

8. The heating apparatus according to claim 1,
further comprising a first shielding unit and a second shielding unit that is configured to be mounted in the heating unit,
wherein the first shielding unit is configured to shield the connecting electrodes from the thermal radiation generated at the outlet end, and the second shielding unit is configured to prevent electrical arc in the heating unit.

9. The heating apparatus according to claim 8,
wherein the first shielding unit comprises gas permeable insulator materials, and/or porous Al₂O₃ or mullite, and
wherein the second shielding unit comprises a dense Al₂O₃.

10. The heating apparatus according to claim 1,
wherein the at least one heating element is configured to provide for a heating channel that is defined between the inlet end and outlet end thereof.

11. The heating apparatus according to claim 10,
wherein the heating channel has a curved shape that includes at least two arms extending from the inlet end towards the outlet end along the longitudinal axis, and at least one web-section connecting the at least two arms, which web-section is disposed at the outlet end, and/or the heating channel has a U shape including two arms of straight, curved or meander shape.

12. The heating apparatus according to claim 10,
wherein the heating channel has a serpentine shape, wherein the free ends of the heating channel are disposed at the inlet end of the at least one heating element and is configured to be connected to the connecting electrodes.

13. The heating apparatus according to claim 1, wherein
a) the at least one heating unit comprises two or more heating elements that are electrically connected in series; and/or
b) the heating apparatus comprises two or more heating units, each is connected to the electrical unit via the connecting electrodes.

14. The heating apparatus according to claim 13,
wherein the two or more heating elements are electrically connected via further connecting electrodes disposed at the corresponding inlet ends of each of the two or more heating elements.

15. A method of heating fluid streams for industrial processes, comprising:
heating the at least one heating element of the at least one heating unit via the electronical unit, wherein the electrical unit is connected via connecting electrodes to an inlet end of the at least one heating element;
introducing fluid streams through the inlet end of the at least one heating element, and controlling the temperature of the fluid stream at the outlet end of the at least one heating element using the electrical unit, wherein the electrical unit is configured to be operated in a current control mode.

16. A heating device comprising:
at least one heater element, and
heater connecting electrodes, wherein the heater connecting electrodes are configured to be connected to the at least one heater element,
wherein the at least heater element is configured to heat a target unit through radiant heating, and/or
the at least one heater element is configured to be heated to a temperature ranging from 600 to 2800°C.,
wherein the heater connecting electrodes comprise a liquid material or a liquefiable material, the heater connecting electrodes further comprising a conductive element that is configured to contain the liquid or liquefiable material, or
wherein the heater connecting electrodes comprise a solid material in the form of a conductive element.

17. The heating device according to claim 16,
wherein the conductive element is configured to be connected to the at least one heater element through sintering or pressure assisted bonding, and/or
wherein the conductive element comprises a conductive ceramic material, Nb-doped TiO₂, highly doped ZrO₂, or Mg-doped Cr₂O₃.

18. The heating device according to claim 16,
wherein the liquid material or the liquefiable material comprises tin, tin alloys, brass alloys, brazing alloys, silver, silver alloys, platinum, or platinum alloys.

19. The heating device according to claim 16,
wherein the at least one heater element comprises two or more heating elements that are connected together in parallel or in series, and/or
the at least one heater element comprises conductive ceramics or conductive oxide ceramics having a negative temperature coefficient.
